(19) United States
(12) Patent Application Publication
(10) Pub. No.: US 2025/0124218 A1
(43) Pub. Date: Apr. 17, 2025

(54) Method and electronic device for generating article content

(71) Applicant: Hangzhou Alibaba International Internet Industry Co., Ltd., Hangzhou (CN)

(72) Inventors: Guofeng Sheng, Hangzhou (CN); Hua Gu, Hangzhou (CN); Lei Liu, Hangzhou (CN); Zhijie Zheng, Hangzhou (CN)

(21) Appl. No.: 18/908,594

(22) Filed: Oct. 7, 2024

(30) Foreign Application Priority Data
Oct. 16, 2023 (CN) 202311336600.0

(51) Int. Cl. G06F 40/166; G06F 16/953; G06F 40/137; G06F 40/253; G06F 40/40; G06T 11/00

(52) U.S. Cl. CPC G06F 40/166; G06F 16/953; G06F 40/137; G06F 40/253; G06F 40/40; G06T 11/00

(57) ABSTRACT

A method and an electronic device for generating article content are disclosed. The method includes: constructing a subject keyword library by collecting industry trend data, and collecting content materials for article generation; in response to a request for generating an industry information article, determining a target subject keyword and a prompt word text for dialogue with an artificial intelligence AI large language model, to facilitate a generation of an article subject; screening multiple segments of target content materials from the content materials; constructing a prompt word text for dialogue with the AI large language model according to the article subject and the target content materials to generate an article outline, the article outline including multiple sub-subjects; and calling the AI large language model multiple times to generate corresponding text contents for the multiple sub-subjects respectively.

### CROSS REFERENCE TO RELATED PATENT APPLICATIONS

This application is related to and claims priority to Chinese Application No. 202311336600.0, filed on 16 Oct. 2023 and entitled “Method and Electronic Device for Generating Article Content,” which are incorporated herein by reference in their entirety.

### TECHNICAL FIELD

The present disclosure relates to the technical field of content generation, and in particular to methods and electronic devices for generating article content.

### BACKGROUND

In commodity information service systems, there are often some industry information articles, such as articles about popular women's clothing trends, etc. These articles can be provided to consumers through methods such as link push, etc., so as to attract users through content thereof to increase buyer retention. Or, consumers can also obtain specific articles through search engines, etc.

However, in existing technologies, such industry information articles are usually generated by manual writing. For example, some industry experts and other authors can make introductions on aspects such as industry trends, innovative technologies, market changes, industry mergers, etc., and create complete articles. However, such method has problems such as high content production costs and relatively low production efficiency, etc., so that the amount of content is small and cannot meet the growing user needs. In addition, the content is usually relatively monotonous, and cannot attract users' continued retention through richer content.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “techniques,” for instance, may refer to device(s), system(s), method(s) and/or processor-readable/computer-readable instructions as permitted by the context above and throughout the present disclosure.

The present disclosure provides a method and an electronic device for generating article content, which can realize an automatic generation of industry information articles and ensure the quality of article content generation.

The present disclosure provides the following solution:

A method for generating article content, includes:

constructing a subject keyword library by collecting industry trend data, and
collecting content materials for article generation based on subject keywords in the library;
in response to a request for generating an industry information article, determining a target subject keyword, and constructing a prompt word text for dialogue with an artificial intelligence AI large language model according to the target subject keyword, to enable the AI large language model to generate an article subject;
screening multiple segments of target content materials from the content materials according to the article subject and the target subject keyword;
constructing a prompt word text for dialogue with the AI large language model according to the article subject and the target content materials, to enable the AI large language model to generate an article outline according to the multiple segments of the target content materials, the article outline including multiple sub-subjects; and
calling the AI large language model multiple times to generate corresponding text contents for the multiple sub-subjects respectively according to the article subject, the multiple sub-subjects and the target content materials, to generate a target article according to the article subject and the text contents corresponding to the multiple sub-subjects.

The method further includes:
according to pre-divided populations and respective population labels corresponding thereto, marking the subject keywords to establish an association relationship between the subject keywords and the populations, wherein determining the target subject keyword in response to the request for generating the industry information article includes:
in response to a request for generating an industry information article for a target population, determining target subject keyword(s) having an association relationship with the target population.

The content materials include: a content material with timeliness, so that the generated target article includes a corresponding content with timeliness.

The content materials are also associated with timeliness and/or source information, so that when generating an article, the target content materials are filtered and selected in combination with the timeliness and/or the source information.

Screening the multiple segments of the target content materials from the content materials includes:
screening multiple target content materials with a same or similar style/type from the content materials, to allow a content in the generated target article to have uniformity in style and/or writing ideas.

When generating the article outline, the AI large language model is specifically used to: generate sub-subjects for the multiple target content materials respectively, and extract multiple target sub-subjects from the sub-subjects corresponding to the multiple target content materials respectively, to generate the article outline from the multiple target sub-subjects.

The method further includes:
after the AI large language model generates the corresponding text contents for the multiple sub-subjects respectively, extracting a timeliness-related content in the generated text contents, and determining content keywords of the timeliness-related content; and
initiating a content search to a target search engine system according to the content keywords, and performing a text matching between a searched content and the timeliness-related content generated by the AI large language model to determine whether factual errors in the timeliness-related content generated by the AI large language model exist.

Generating the corresponding text contents for the multiple sub-subjects respectively includes:
using an AI large language model of a text generation type to generate the corresponding text contents for the multiple sub-subjects, and using an AI large language model of an image generation type to generate corresponding illustration contents for the multiple sub-subjects.

Before using the AI large language model of the image generation type to generate an illustration content for a target sub-subject, using the AI large language model of the text generation type to generate a prompt word text for dialogue with the AI large language model of the image generation type, to enable the AI large language model of the image generation type to generate the illustration content for the target sub-subject according to the prompt word text.

Using the AI large language model of the text generation type to generate the prompt word text for dialogue with the AI large language model of the image generation type includes:
according to the multiple sub-subjects and the generated text contents corresponding to the multiple sub-subjects, constructing a prompt word text for the AI large language model of the text generation type, to enable the AI large language model of the text generation type to generate the prompt word text for dialogue with the AI large language model of the image generation type.

Using the AI large language model of the text generation type to generate the prompt word text for dialogue with the AI large language model of the image generation type includes:
if the content materials include image content materials that are associated with text content materials, determining image content materials associated with text content materials to be used when generating the texts content corresponding to the multiple sub-subjects, and using the AI large language model to generate text description contents of the image content materials; and
using the text description contents corresponding to the image content materials to construct the prompt word text for the AI large language model of the text generation type, so that the AI large language model of the text generation type generates the prompt word text for dialogue with the AI large language model of the image generation type.

An apparatus for generating article content, includes:
a word library generation unit, configured to construct a subject keyword word library by collecting industry trend data, and collect content materials for article generation based on subject keywords in the word library;
a first prompt word text construction unit, configured to respond to a request for generating an industry information article, determine a target subject keyword, and construct a prompt word text for dialogue with an artificial intelligence (AI) large language model based on the target subject keyword, to enable the AI large language model to generate an article subject;
a content material screening unit, configured to filter and select multiple segments of target content materials from the content materials based on the article subject and the target subject keyword;
a second prompt word text construction unit, configured to construct a prompt word text for dialogue with the AI large language model according to the article subject and the target content materials, so that the AI large language model generates an article outline according to the multiple target content materials, the article outline including multiple sub-subjects; and
a main content generation unit, configured to call the AI large language model multiple times according to the article subject, the multiple sub-subjects and the target content materials, to generate corresponding text contents for the multiple sub-subjects respectively, so as to generate a target article according to the article subject and the corresponding text contents of the multiple sub-subjects.

A computer-readable storage medium stores a computer program. The computer program, when executed by a processor, implements the steps of any of the methods described above.

An electronic device includes:
one or more processors; and
a memory associated with the one or more processors, the memory being configured to store program instructions, which execute the steps of any of the methods described above when read and executed by the one or more processors.

According to exemplary embodiments provided by the present disclosure, the present disclosure discloses the following technical effects:

Through the embodiments of the present disclosure, in order to be able to automatically generate industry information articles through an AI large language model and avoid the content being too general and empty, first, a subject keyword library can be constructed by collecting industry trend data, and content materials for article generation can be collected based on subject keywords in the library. When an article is needed to be generated, a target subject keyword can be first used, and a prompt word text for dialogue with an artificial intelligence AI large language model can be constructed based on the target subject keyword, so that the AI large language model can generate an article subject. Afterwards, multiple target content materials can be screened out from the content materials based on the article subject and the target subject keyword, and then, a prompt word text for dialogue with the AI large language model can be constructed based on the article subject and the multiple target content materials, so that the AI large language model can generate an article outline based on the multiple target content materials. The article outline includes multiple sub-subjects. Finally, the AI large language model is called multiple times to generate corresponding text contents for the multiple sub-subjects respectively based on the article subject, the multiple sub-subjects, and the multiple target content materials, so as to generate a target article based on the article subject and the text contents corresponding to the multiple sub-subjects. In this way, since industry information articles can be generated by an AI large language model, and a pre-constructed keyword library and content materials are used in a generation process, it is possible to effectively limit the free play ability of the AI large language model to ensure the quality of article generation. In addition, by a method that first generates an article subject, then generates an article outline, and finally generates a specific text content divided in paragraphs, the content generated each time can be within the scope supported by the AI big model, and the generation task of the AI big model each time can be more focused, thereby further ensuring the quality of the generated text content.

Since content materials are provided to the AI big model when the AI big model generates an article, and such content materials can be collected from forum websites, search engine systems and other sources, timely contents can be included. Correspondingly, articles that are generated can also include timely contents, thereby meeting requirements for presenting timely contents in industry information articles.

In addition, when generating a text content of an article, in addition to the text content, an illustration content can also be included. Specifically, when generating an illustration content, the illustration content can be generated by an AI big model of a “text-generates-picture” type. However, in order to be able to construct a suitable prompt word text for this “text-generates-picture” type AI big model to ensure the quality of an illustration that is to be generated, in a preferred embodiment, the AI big model of a “text-generates-text” type can also be used to generate a prompt word text for the AI big model.

Apparently, any product implementing the present disclosure does not necessarily need to achieve all of the advantages described above at the same time.

### BRIEF DESCRIPTION OF THE DRAWINGS

In order to more clearly illustrate the technical solutions in the embodiments of the present disclosure or existing technologies, drawings used in the embodiments will be briefly introduced below. Apparently, the drawings described below represent only some embodiments of the present disclosure. For one of ordinary skill in the art, other drawings can be obtained based on these drawings without making any creative work.

FIG. 1 is a schematic diagram of a system architecture provided by the embodiment of the present disclosure.

FIG. 2 is a flowchart of a method provided by the embodiments of the present disclosure.

FIG. 3 is a schematic diagram of an apparatus provided by embodiments of the present disclosure.

FIG. 4 is a schematic diagram of an electronic device provided by the embodiments of the present disclosure.

### DETAILED DESCRIPTION

In combination with the drawings in the embodiments of the present disclosure, the technical solutions in the embodiments of the present disclosure will be clearly and completely described as follows. Apparently, the described embodiments represent only some and not all of the embodiments of the present disclosure. Based on these embodiments in the present disclosure, all other embodiments obtained by one of ordinary skill in the art belong to the scope of protection of the present disclosure.

In the embodiments of the present disclosure, in order to reduce the production cost of article contents and improve efficiency, the ability of AI (Artificial Intelligence) large language model (LLM, referred to as AI large model) can be employed to generate the article contents.

For ease of understanding, an AI large language model is first briefly introduced below. An AI large model can refer to a type of foundation model, which specifically can refer to a model with a huge number of parameters that is trained using a massive amount of data and is capable of adapting to a series of downstream tasks. For AI big models, not only are there huge number of parameters in terms of parameter scale (with the continuous iteration of the model, the number of parameters will usually increase exponentially, from 100 million to 1 trillion, and then to 100 trillion, or even more), but also, from the perspective of modal support, the AI big models have gradually evolved from supporting single tasks in a single modality such as pictures, images, texts, voices, and videos to supporting multiple tasks in multiple modalities. In other words, large models usually also have the ability to efficiently understand information in multiple modalities, the ability to perceive across modalities, and the ability to migrate and execute across differentiated tasks, and may even have the ability to perceive multimodal information as embodied in the human brain.

From another perspective, the AI big model is an abbreviation of “artificial intelligence pre-trained large model,” which includes two meanings: “pre-training” and “big model”. The combination of these two produces a new artificial intelligence model, i.e., a model that does not need fine-tuning after pre-training on a large-scale data set, or only needs fine-tuning on a small amount of data, to support various downstream applications. In other words, benefited from “large-scale pre-training+fine-tuning” paradigm, the AI big model can adapt well to different downstream tasks and show its strong versatility. Under a condition of sharing parameters, this type of universal AI big model can achieve superior performance by making corresponding fine-tuning in different downstream application scenarios, breaking through the limitation that traditional AI models are difficult to be generalized to other tasks.

From the perspective of processing results, the above AI big model is also a generative model. This type of model can not only predict results based on features, but also “understand” how data is generated, and “create” new data based thereon.

Since the AI big model has the ability to create content, the AI big model can be applied to article creation in the embodiments of the present disclosure to build a low-cost, batch and personalized content production capability. However, in implementations, articles of types such as industry information, etc., may have the characteristics of being relatively long, and the content generated by the AI big model at one time is limited. If the AI big model is directly called to generate the entire article, the article that is written is often general and may not include valuable content such as the current popular trends for analysis, etc.

In response to the above problems, the embodiments of the present disclosure provide a corresponding solution. In this solution, in order to avoid articles written by the AI big model being too general and empty, a subject keyword library can be constructed in advance by collecting industry trend data, etc. In addition, content materials can be obtained based on such subject keywords. For example, specific subject keywords can be used to collect relevant text contents from relevant search engines, major forum websites and other sources. If a text is associated with an image content, the text and the image content can also be collected together. Afterwards, in order to facilitate retrieval, the collected contents can also be vectorized, and specific contents can be processed by word segmentation, fragmentation, etc., and a corresponding index can be established. In addition, for some time-sensitive content, attribute information such as timeliness and source, etc., can also be added to facilitate subsequent content screening. This type of content materials can be used as a type of content “base material” for subsequent use by the AI big model to generate articles.

Later, when an industry information article is needed to be generated, subject keyword(s) can be first determined, and then the AI big model can first generate an article subject based on the subject keyword(s). After generating the article subject, the AI big model can first generate an article outline, i.e., first determining which paragraphs an article is roughly divided into, and sub-subjects corresponding to each paragraph. Specifically, when generating the outline, an outline structure can be enriched through the capabilities of the AI big model while limiting the free play capability of the AI big model to avoid a phenomenon of inconsistent article content. Specifically, before generating the outline, some relevant content materials can be filtered and selected from the content materials based on the generated article subjects and the previous target subject keyword(s). The AI big model is then used to analyze these content materials, generate sub-subjects corresponding to these content materials, select multiple target sub-subjects from these sub-subjects, and then use these target sub-subjects to form the article outline.

After generating the article subject and the article outline, the AI big model is called multiple times, so that the AI big model can generate corresponding contents for each specific sub-subject according to <main subject, sub-subject> pairs. A content herein can include a text content, an image content, etc. Finally, the main subject and the corresponding contents generated under each sub-subject can form a complete article.

In this way, since a subject keyword library and a content material library are pre-established, during a process of generating an article, the generation of article content can be gradually completed in an order of subject, outline, and content under each sub-subject, so that the AI big model can be used to achieve fully automated generation of articles, and an article generated thereby is based on content materials, so that the problem of too empty and generated content in the article can be avoided.

In addition, in order to make a generated article more targeted to pain points of a group of people, subject keywords can also be marked according to pre-divided groups of people and labels of these crowds, so as to establish an association relationship between the groups of people and the subject keywords. Specifically, the subject keywords can be marked according to preferences of the crowds for the subject keywords. In this way, when generating an article, a group of people can first be selected, and a targeted article specifically for the group of people is then generated. At this time, specific articles can be generated based on the subject keywords associated with these groups of people, etc.

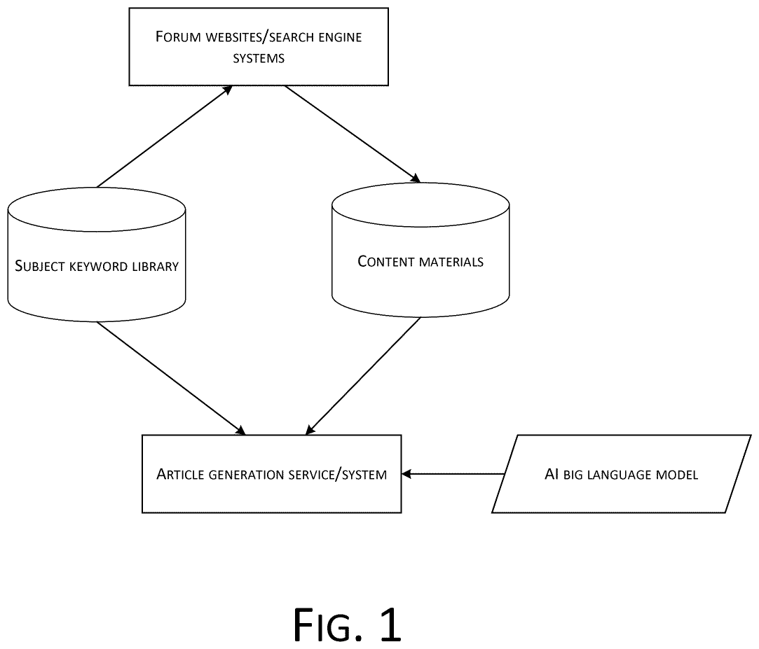

From the perspective of system architecture, referring to FIG. 1, the embodiments of the present disclosure can provide a service or a system for generating articles of types such as industry information, etc., and can a pre-established subject keyword library, and obtain relevant content materials based on keywords in the library. After that, an AI big model can be called through the system, and a prompt word text for dialogue with the AI big model can be generated. In addition, content materials can be filtered and selected, so that the AI big model can gradually complete the generation of article content in an order of article subject, outline, and text contents under each sub-subject. An article generated thereby can be pushed to consumer users through associated applications, etc., or users can also obtain specific article content by actively searching through a search engine system, etc.

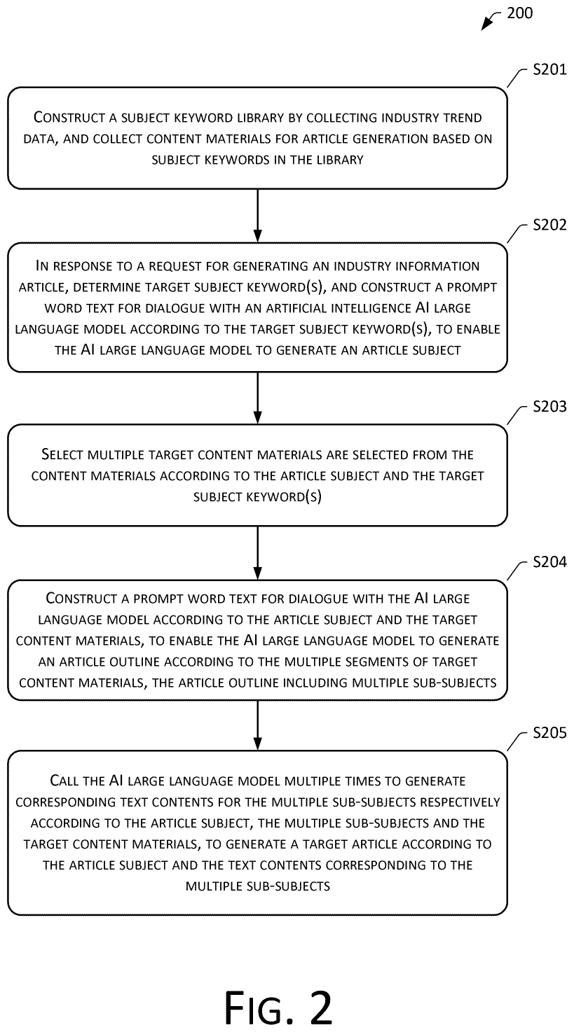

Details of implementations of the solution provided by the embodiments of the present disclosure are described in detail below. First, the embodiments of the present disclosure provide a method 200 for generating an article content. Referring to FIG. 2, the method 200 may include:

S201: Construct a subject keyword library by collecting industry trend data, and collect content materials for article generation based on subject keywords in the library.

In order to ensure the quality of articles generated by the model, in the embodiments of the present disclosure, a subject keyword library can be established first, which involves the production of keywords. Specifically, identifying industry trends is the core of keyword production. In implementations, a basic keyword library can be established based on hot search words in the sites of associated commodity information service systems, industry trend words summarized in the search system, and hot search words in the industry forums, etc. Afterwards, in order to further expand the richness of the keyword library, including different expressions that have the same meaning, etc., these keywords can also be expanded by calling a word expansion interface of a relevant search engine system, and more subject keywords related to industry trends, etc. are entered into the library.

After the keyword library is established, content materials for article generation can be collected based on subject keywords in the library. Specifically, relevant contents can be obtained from major network forums, search engines, etc. based on subject keywords in the library. For example, contents related to a specific subject keyword can be searched according to a search interface provided by specific search engine and other systems, wherein the contents herein can mainly include text contents, for example, some published articles, etc. If image contents such as related images exist in the texts, these can also be obtained together.

Apparently, the content obtained in this way may be messy and includes some invalid content. Therefore, the obtained content can also be screened to filter out invalid content. In implementations, in the embodiments of the present disclosure, a process of screening an obtained content can also be completed by the AI big model. Specifically, a prompt word text (Prompt) for dialogue with the AI big model can be generated by a program, wherein the prompt word text herein can be a text expressed in natural language, e.g., “Big model, please help me determine which of these obtained contents are invalid and filter them out”, etc. Afterwards, the AI big model can filter the obtained contents and retain valid contents.

It should be noted here that, in the embodiments of the present disclosure, since the content materials are obtained by searching and obtaining from systems such as forum websites, search engines, etc., they may include some contents with timeliness characteristics, such as a certain news event, etc. In this way, when generating an article based on these content materials, the article can also include such timely content. In implementations, after collecting specific contents, attribute information such as timeliness, source, style/type (for example, popular expert style, etc.), etc., may also be added to the contents to facilitate subsequent screening of content materials. Apparently, when the AI big model screens the contents, the AI big model can also directly add the above-mentioned attributes such as timeliness, sources, etc., to the contents.

In addition, after specific contents are obtained from forum websites, search engines, etc., in order to facilitate subsequent retrieval or model understanding, the contents can also be vectorized. For example, word segmentation or fragmentation may be performed on the obtained text contents, and corresponding vectors can be generated for each word, sentence, paragraph, etc., respectively. Attribute values in multiple dimensions such as timeliness and source, etc., can be reflected in a vector. These vectorized expressions can be saved as content materials, and subsequent article generation can be performed based mainly on these content materials. Apparently, in implementations, this type of content material library can also be updated in real time or quasi-real time. For example, searching using keywords in the library can be performed repeatedly every day, every hour, every half hour, etc., to obtain new contents and add them to the content material library, so that the content material library can store the latest time-sensitive content, etc.

In order to realize article generation for a specific group of people, the subject keywords can also be marked and managed according to pre-divided population portraits, according to dimensions of country/industry/language/search volume. In other words, the subject keywords in the library can be marked using population labels corresponding to pre-divided populations. Specifically, determining which groups of people are interested in a subject keyword can be made, and group labels corresponding to these groups of people can then be used to mark the subject keyword. For example, if a certain subject keyword is “popular women's clothing”, and groups A, B, and C may have a preference for this subject keyword, the “popular women's clothing” keyword can be added with labels such as “group A, B, C”. Apparently, in implementations, the group labels corresponding to groups A, B, C, etc., can also be generalized and summarized, and the keywords is then marked, for example. In this way, when an article is generated at a later time, groups can be selected first, and subject keywords matching the selected groups can then be determined according to labels associated with the subject keywords. Afterwards, the article is generated, so that users can see the contents they are interested in.

S202: In response to a request for generating an industry information article, determine target subject keyword(s), and construct a prompt word text for dialogue with an artificial intelligence AI large language model according to the target subject keyword(s), to enable the AI large language model to generate an article subject.

After establishing the subject keyword library and the content material library, the AI large model can be called to generate articles. Specifically, when generating an article, to ensure the quality of the copywriting of the generated article, first of all, it is necessary to ensure that there is a relatively good article subject. If the selection of the subject can keep up with the trend, it can obtain greater exposure in a short time. At the same time, the article subject can be of interest to users and highly relevant to the industry, so that the article generated is more in line with user needs. Therefore, when generating a specific article content, the article subject can be generated first. In order to improve the quality of the article subject, in the embodiments of the present disclosure, target subject keyword(s) can be first determined from the previously established library, and then the AI large model generates the article subject based on the target subject keyword(s).

There are a number of methods to determine a target subject keyword. For example, in one method, if an universal article is needed to be generated, random selection may be made from the library, or keywords with popular attributes may be selected as a target keyword, and so on. The article may then be generated based on this target keyword. At this time, the generated article will be universal, and can be delivered or pushed to multiple different groups of people.

Alternatively, in another method, a group of people may be selected before generating an article, that is, a more targeted article may be generated for a specific group of people. For example, a process of selecting a group of people may be completed by a staff member in the system. After the selection of the group of people is completed, associated target keywords may be determined according to the selected group of people, and an article may then be generated for the selected group of people based on the target keywords.

Specifically, after determining a target subject keyword, this subject keyword can be used to construct a prompt word text for dialogue with the AI large language model, so that the AI large language model can generate an article subject. For example, if the subject keyword is “fashionable women's clothing”, a constructed prompt word text may be “I want to write an industry information article about ‘fashionable women's clothing’, please help write an article subject”, etc. The AI large model can then generate a specific article subject. Apparently, in implementations, some more representative and high-quality article subjects can be inputted into the AI large model in advance, so that the AI large model can learn the knowledge related to generating article subjects. In addition, in implementations, article subjects generated by the AI large model can also be risk filtered by calling a relevant risk filtering interface. If some sensitive words, for example, are found in a subject generated by the AI large model, the AI large model can be triggered to regenerate a new subject, etc.

S203: Select multiple target content materials are selected from the content materials according to the article subject and the target subject keyword(s).

After generating the article subject, as mentioned above, if the AI big model is allowed to generate the article freely, it may be necessary to make enough attempts on the prompt word text. Furthermore, different prompt word texts need to be customized for different topics, and a lot of effort needs to be spent on manual polishing at the later stage. The effect is extremely unstable, and the quality of the article will be difficult to be effectively controlled. In addition, due to limitations of the corpus during a training process of a model or mistakes made by the model at a reasoning stage, the AI big model may generate information that is inconsistent with the facts when generating a copy, and it is difficult to detect it.

Based on the above situation, after generating the article subject, the AI big model can first generate an article outline, that is, determining roughly which paragraphs are in the article and what sub-subjects of each paragraph are. In theory, if specific article subjects and some examples related to outlines are provided to the AI big model, the AI big model can generate similar article outlines. However, in order to improve the quality of outline generation, in the embodiments of the present disclosure, the target content materials related to the article subject and the target subject keyword(s) can be first screened out from the previously generated content material library, and then the AI big model can be used to generate an article outline and a subsequent text content based on these content materials.

When screening the content materials, in addition to matching with the article subject and target subject keyword(s), multiple segments of target content materials with the same or similar style/type can also be screened out from the content materials, so that the content in the generated target article has uniformity in style and/or writing ideas. In other words, since the contents in the content material library may be very complicated, even if they include the same subject keyword, there may be multiple different styles/types due to different writing styles of authors. If they are inputted into the AI big model without distinction, the generated article may be inconsistent in style or behavior ideas, etc.

Therefore, when screening, content materials with the same or similar style/type can be screened as many as possible. Specifically, since specific content materials may be associated with attributes such as source, style/type, etc., content materials can be screened based on these attributes. For example, contents can be selected from articles of the same style/type that are from forum sources of the same high-quality and by the same or similar high-quality authors. In this way, the big model can imitate the author's style and writing ideas and write copy that meets user needs.

It needs to be noted here that the specifically selected target content materials may mainly include text content materials. If a specific text content material is associated with an image content material, the image content material can also be selected for subsequent generation of text content.

S204: Construct a prompt word text for dialogue with the AI large language model according to the article subject and the target content materials, to enable the AI large language model to generate an article outline according to the multiple segments of target content materials, the article outline including multiple sub-subjects.

After selecting the target content materials, a prompt word text for dialogue with the AI large language model may be constructed according to the article subject and the target content materials, so that the AI large language model generates an article outline according to the multiple segments of target content material, wherein the article outline may include multiple sub-subjects. For example, if the target subject keyword is “popular women's clothing”, the generated article subject may be “2023 autumn and winter women's clothing fashion trend analysis”, and corresponding sub-subjects in the generated article outline may include: fashion trends, color matching, personality style, etc.

Generating an article outline by the AI large language model can also be divided into multiple steps. For example, sub-subjects can first be generated for multiple segments of the selected target content materials, and then multiple target sub-subjects can be extracted from the sub-subjects corresponding to the multiple segments of the target content materials, so that an article outline can be generated from the multiple target sub-subjects.

For example, if 100 paragraphs of content materials are previously selected, when generating the outline, the AI large model can first generate corresponding sub-subjects for these 100 paragraphs of content materials. Apparently, there may be some repetitions or similarities in these sub-subjects. Therefore, after obtaining 100 sub-subjects, the AI large model can further summarize these 100 sub-subjects and extract a certain number of target sub-subjects, such as fashion trends, color matching, personality style, etc., as described above.

S205: Call the AI large language model multiple times to generate corresponding text contents for the multiple sub-subjects respectively according to the article subject, the multiple sub-subjects and the target content materials, to generate a target article according to the article subject and the text contents corresponding to the multiple sub-subjects.

After generating the article subject and the multiple sub-subjects in the outline, the AI large language model can be called multiple times according to the article subject, the multiple sub-subjects in the article outline and the target content materials to generate corresponding text contents for the multiple sub-subjects respectively. For example, if there are six sub-subjects in total, six calls for the large model can be made, and so on. In this way, since each call only needs to generate content in a paragraph corresponding to a sub-subject, the task of the AI large model is more focused, and correspondingly, the quality of the generated text content can be guaranteed. At the same time, the length of the generated content can also be within a range supported by the AI large model. Since the sub-subjects are generated based on the target content materials previously screened, each sub-subject can also be associated with one or more segments of the target content materials. Therefore, when generating a text content for a specific sub-subject, the text content can also be generated based on one or more segments of the target content materials corresponding to the sub-subject. In this way, each time when the AI large model is called, specific input information can include the article subject, a sub-subject, and one or more segments of target content material associated with the sub-subject.

Specifically, when generating the main text content corresponding to the sub-subject, the main text content may include a text content, and may also include an illustration content. Therefore, in implementations, the AI big model may include an AI big model for generating text contents (that is, a “text-generate-text” type of big model), and an AI big model for generating image content (that is, a “text-generate-picture” type of big model), and other different models.

For the text content part, a prompt word text for communicating with the AI big model can be constructed based on the article subject, the sub-subjects and the corresponding target content materials, and then the AI big model used to generate text contents can generate a specific text content based on the prompt word text. In practical applications, since a content material may include some timely content, the generated text content may also include some timely content. For this kind of timely content, the authenticity of the content is more important. In the process of generation by the AI big model, some factual errors may be introduced. For example, content generated by the AI big model includes content such as “a certain brand held a press conference yesterday”, but it may not actually be “yesterday”, or it may be another brand, etc. Therefore, in an exemplary embodiment, after the AI language model generates a corresponding content for a target sub-subject, content related to timeliness can be extracted, and content keyword(s) can be determined based on the content related to timeliness. A content search can then be initiated to a relevant search engine system based on the content keyword(s), and a searched content can be matched with the content related to timeliness generated by the AI model to determine whether there are any factual errors in the content related to timeliness generated by the AI model. If there are, rewriting can be performed according to the searched content, or the AI model can be requested for performing the generation again, etc.

As for the illustration part, an AI model of a “text-generate-picture” type can be used to generate image content. Specifically, a corresponding image content can be generated for each sub-subject, or some of the sub-subjects can be selected to generate image content. For sub-subjects that specifically need to generate image content, a prompt word text for dialogue with the “text-generate-picture” type AI model can be constructed based on information such as the sub-subjects and the text contents that have been generated for the sub-subjects. The “text-generate-picture” type AI model then generates corresponding illustration contents based on this prompt word text.

However, in implementations, since there are some professional terms in image generation, including lighting background, etc., if these professional terms can be described more accurately in a prompt word text, the quality of a generated illustration can be improved, or an illustration content that better matches a sub-subject and a corresponding text content can be generated. However, it may be difficult for such non-drawing professionals to write such prompt word text. Therefore, in the embodiments of the present disclosure, before using the AI big language model of the image generation type to generate an illustration content for a target sub-subject, the AI big language model of the text generation type can be used to generate a prompt word text for dialogue with the AI big language model of the image generation type, so that the AI big language model of the image generation type can generate the illustration content for the target sub-subject based on the prompt word text. In other words, the prompt word text used to dialogue with the AI big model of the “text-generate-picture” type can be generated by the AI big model of the “text-generate-text” type.

Specifically, when the AI big model of the “text-generate-text” type generates a prompt word text for the AI big model of the “text-generate-picture” type, the AI big model of the “text-generate-text” type itself also needs a prompt word text, and there are multiple methods to construct the prompt word text. For example, in one method, a prompt word text of the “text-generate-text” type AI big language model can be constructed according to a sub-subject and a generated text content corresponding to the sub-subject. For example, a prompt word text specifically constructed for the “text-generate-text” type AI big language model may be: “I wrote a text with a sub-subject of xx for an article with a subject of xx, and a text content is xx. I want the big model to generate an illustration for this content. How should I ask the big model”, etc. In this way, the AI big language model of the “text-generate-text” type can generate a prompt word text for dialogue with the AI big language model of the “text-generate-picture” type.

Alternatively, in another method, if a content material includes an image content material and is associated with a text content material, the image content material associated with the text content material used to generate a text content corresponding to a sub-subject can be determined. The AI big language model can then be used to generate a textual description content of the image content material, that is, convert the image content material into a text description. After that, the textual description content corresponding to the image content material can be used to construct a prompt word text for the AI big language model of the “text-generate-text” type, so that the AI big language model of the “text-generate-text” type can generate the prompt word text for dialogue with the AI big language model of the “text-generate-picture” type.

In other words, when generating a prompt word text for the AI large language model of the “text-generate-picture” type by the AI large language model of the “text-generate-text” type, it is also necessary to construct a prompt word text for the AI large language model of the “text-generate-text” type. The prompt word text for the AI large language model of the “text-generate-text” type can be constructed according to a sub-subject and its corresponding generated text content, or can be constructed according to an image content material included in a content material corresponding to the sub-subject. At this time, the image content material can first be converted into a textual description content, and the prompt word text for the AI large language model of the “text-generate-text” type is then constructed based on this textual description content, so that the AI large language model of the “text-generate-text” type can generate a prompt word text for dialogue with the AI large language model of the “text-generate-picture” type.

In summary, through the embodiments of the present disclosure, in order to be able to automatically generate industry information articles through an AI large language model and avoid the content being too general and empty, first, a subject keyword library can be constructed by collecting industry trend data, and content materials for article generation can be collected based on subject keywords in the library. When an article is needed to be generated, a target subject keyword can be first used, and a prompt word text for dialogue with an artificial intelligence AI large language model can be constructed based on the target subject keyword, so that the AI large language model can generate an article subject. Afterwards, multiple target content materials can be screened out from the content materials based on the article subject and the target subject keyword, and then, a prompt word text for dialogue with the AI large language model can be constructed based on the article subject and the multiple target content materials, so that the AI large language model can generate an article outline based on the multiple target content materials. The article outline includes multiple sub-subjects. Finally, the AI large language model is called multiple times to generate corresponding text contents for the multiple sub-subjects respectively based on the article subject, the multiple sub-subjects, and the multiple target content materials, so as to generate a target article based on the article subject and the text contents corresponding to the multiple sub-subjects. In this way, since industry information articles can be generated by an AI large language model, and a pre-constructed keyword library and content materials are used in a generation process, it is possible to effectively limit the free play ability of the AI large language model to ensure the quality of article generation. In addition, by a method that first generates an article subject, then generates an article outline, and finally generates a specific text content divided in paragraphs, the content generated each time can be within the scope supported by the AI big model, and the generation task of the AI big model each time can be more focused, thereby further ensuring the quality of the generated text content.

Since content materials are provided to the AI big model when the AI big model generates an article, and such content materials can be collected from forum websites, search engine systems and other sources, timely contents can be included. Correspondingly, articles that are generated can also include timely contents, thereby meeting requirements for presenting timely contents in industry information articles.

In addition, when generating a text content of an article, in addition to the text content, an illustration content can also be included. Specifically, when generating an illustration content, the illustration content can be generated by an AI big model of a “text-generates-picture” type. However, in order to be able to construct a suitable prompt word text for this “text-generates-picture” type AI big model to ensure the quality of an illustration that is to be generated, in a preferred embodiment, the AI big model of a “text-generates-text” type can also be used to generate a prompt word text for the AI big model.

It needs to be noted that the use of user data may be involved in the embodiments of the present disclosure. In practical applications, user-specific personal data can be used in the solution described herein within the scope permitted by applicable laws and regulations of the country (for example, a user's explicit consent, a user's real notification, etc.).

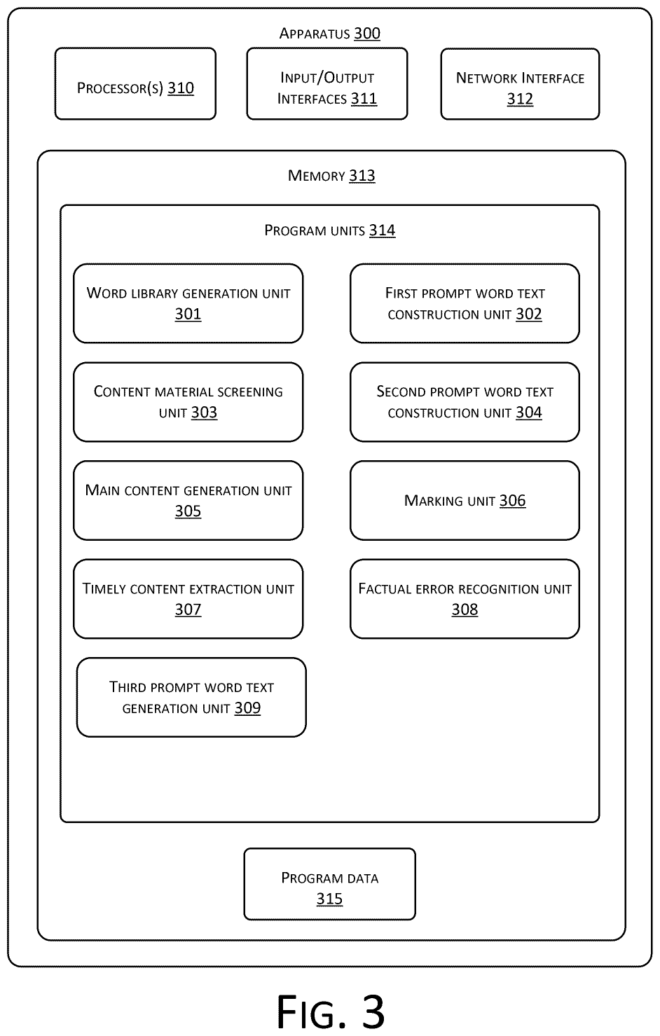

Corresponding to the aforementioned method embodiments, the embodiments of the present disclosure also provide an apparatus for generating article content. Referring to FIG. 3, the apparatus 300 may include:
a word library generation unit 301, configured to construct a subject keyword word library by collecting industry trend data, and collect content materials for article generation based on subject keywords in the word library;
a first prompt word text construction unit 302, configured to respond to a request for generating an industry information article, determine a target subject keyword, and construct a prompt word text for dialogue with an artificial intelligence (AI) large language model based on the target subject keyword, to enable the AI large language model to generate an article subject;
a content material screening unit 303, configured to screen multiple segments of target content materials from the content materials based on the article subject and the target subject keyword;
a second prompt word text construction unit 304, configured to construct a prompt word text for dialogue with the AI large language model according to the article subject and the target content materials, so that the AI large language model generates an article outline according to the multiple target content materials, the article outline including multiple sub-subjects; and
a main content generation unit 305, configured to call the AI large language model multiple times according to the article subject, the multiple sub-subjects and the target content materials, to generate corresponding text contents for the multiple sub-subjects respectively, to generate a target article according to the article subject and the corresponding text contents of the multiple sub-subjects.

In implementations, the apparatus 300 may also include: a marking unit 306 configured to mark the subject keywords according to pre-divided populations and corresponding population labels to establish association relationships between the subject keywords and the populations.

The first prompt word text construction unit 302 may be configured to determine a target subject keyword that has an association relationship with a target population in response to a request for generating an industry information article for the target population, wherein the content materials include: a content material with timeliness, so that the generated target article includes a corresponding content with timeliness.

In addition, the content materials are also associated with timeliness and/or source information, so that when generating the article, the target content material is screened in combination with the timeliness and/or the source information.

Specifically, the content material screening unit 303 may be configured to:
screen out multiple segments of target content material with a same or similar style/type from the content materials, so that a content in the generated target article has uniformity in style and/or writing ideas.

Specifically, when generating the article outline, the AI large language model is configured to: generate sub-subjects for the multiple segments of the target content material respectively, and extract multiple target sub-subjects from the sub-subjects corresponding to the multiple segments of the target content material respectively, to facilitate generation of the article outline from the multiple target sub-subjects.

In addition, the apparatus 300 may also include:
a timely content extraction unit 307, configured to extract timeliness-related contents in the generated text contents after the AI large language model generates the corresponding text contents for the multiple sub-subjects respectively, and determine content keywords of the timeliness-related contents;
a factual error recognition unit 308, configured to initiate a content search to a target search engine system according to the content keywords, and perform text matching between searched contents and the timeliness-related contents generated by the AI large language model to determine whether factual errors exist in the timeliness-related contents generated by the AI large language model.

The main content generation unit 305 is configured to:
use an AI large language model of a text generation type to generate the corresponding text contents for the sub-subjects, and use an AI large language model of an image generation type to generate corresponding illustration contents for the sub-subjects.

The apparatus 300 may also include:
a third prompt word text generation unit 309, configured to generate a prompt word text for dialogue with the AI large language model of the image generation type using the AI large language model of the text generation type before generating an illustration content for a target sub-subject using the AI large language model of the image generation type, so that the AI large language model of the image generation type generates the illustration content for the target sub-subject according to the prompt word text.

Specifically, the third prompt word text generation unit 309 may be configured to:
construct a prompt word text of an AI large language model of a text generation type according to a sub-subject and a generated text content corresponding to the sub-subject, so that the AI large language model of the text generation type generates a prompt word text for dialogue with an AI large language model of an image generation type.

Alternatively, in another method, the third prompt word text generation unit 309 may be configured to:
if a content material includes an image content material and is associated with a text content material, determine the image content material associated with the text content material used to generate a text content corresponding to a sub-subject, and use the AI large language model to generate a textual description content of the image content material; and
use the textual description content corresponding to the image content material to construct the prompt word text for the AI large language model of the text generation type, so that the AI large language model of the text generation type generates the prompt word text for dialogue with the AI large language model of the image generation type.

In implementations, the apparatus 300 may further include one or more processors 310, an input/output (I/O) interface 311, a network interface 312, and a memory 313. In implementations, the memory 313 may include program units 314 and program data 315. The program units 314 may include one or more of the foregoing units as described in FIG. 3.

In implementations, the memory 313 may include a form of computer readable media such as a volatile memory, a random access memory (RAM) and/or a non-volatile memory, for example, a read-only memory (ROM) or a flash RAM. The memory 313 is an example of a computer readable media.

The computer readable media may include a volatile or non-volatile type, a removable or non-removable media, which may achieve storage of information using any method or technology. The information may include a computer readable instruction, a data structure, a program module or other data. Examples of computer readable media include, but not limited to, phase-change memory (PRAM), static random access memory (SRAM), dynamic random access memory (DRAM), other types of random-access memory (RAM), read-only memory (ROM), electronically erasable programmable read-only memory (EEPROM), quick flash memory or other internal storage technology, compact disk read-only memory (CD-ROM), digital versatile disc (DVD) or other optical storage, magnetic cassette tape, magnetic disk storage or other magnetic storage devices, or any other non-transmission media, which may be used to store information that may be accessed by a computing device. As defined herein, the computer readable media does not include transitory media, such as modulated data signals and carrier waves.

In addition, the embodiments of the present disclosure also provide a computer-readable storage medium, on which a computer program is stored, and when the program is executed by a processor, the steps of any one of the methods in the aforementioned method embodiments are implemented.

An electronic device includes:
one or more processors; and
a memory associated with the one or more processors, the memory being configured to store program instructions, and the program instructions, when read and executed by the one or more processors, execute the steps of any of the methods in the aforementioned method embodiments.

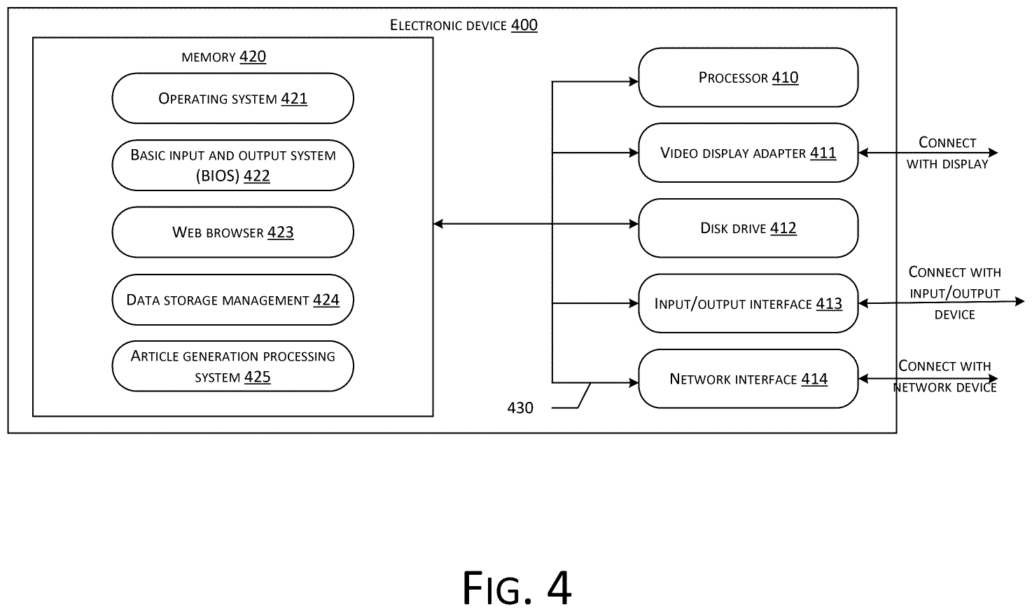

FIG. 4 exemplarily shows the architecture of an electronic device, which may specifically include a processor 410, a video display adapter 411, a disk drive 412, an input/output interface 413, a network interface 414, and a memory 420. The processor 410, the video display adapter 411, the disk drive 412, the input/output interface 413, the network interface 414, and the memory 420 can be communicated with each other through a communication bus 430.

The processor 410 may be implemented by a general-purpose CPU (Central Processing Unit, processor), a microprocessor, an application-specific integrated circuit (ASIC), or one or more integrated circuits, etc., for executing relevant programs to implement the technical solution provided in the present disclosure.

The memory 420 can be implemented in a form of ROM (Read Only Memory), RAM (Random Access Memory), a static storage device, a dynamic storage device, etc. The memory 420 can store an operating system 421 for controlling operations of the electronic device 400, and a basic input and output system (BIOS) for controlling low-level operations of the electronic device 400. In addition, a web browser 423, a data storage management system 424, and an article generation processing system 425, etc. can also be stored. The above-mentioned article generation processing system 425 can be an application program for specifically implementing operations of the steps in the embodiments of the present disclosure as described above. In short, when the technical solution provided by the present disclosure is implemented by software or firmware, relevant program codes are stored in the memory 420, and called and executed by the processor 410.

The input/output interface 413 is configured to connect an input/output module to realize information input and output. The input/output/module can be configured in the device as a component (not shown in the figure), or can be externally connected to the device to provide corresponding functions. The input device may include a keyboard, a mouse, a touch screen, a microphone, various sensors, etc., and the output device may include a display, a speaker, a vibrator, an indicator light, etc.

The network interface 414 is configured to connect a communication module (not shown in the figure) to realize communication interactions between the present device and other devices. The communication module can realize communication through wired means (such as USB, network cable, etc.) or wireless means (such as mobile network, WIFI, Bluetooth, etc.).

The bus 430 includes a passage to transmit information between various components of the device (such as the processor 410, the video display adapter 411, the disk drive 412, the input/output interface 413, the network interface 414, and the memory 420).

It needs to be noted that although the above-mentioned device only shows the processor 410, the video display adapter 411, the disk drive 412, the input/output interface 413, the network interface 414, the memory 420, the bus 430, etc., in a specific implementation process, the device may also include other components necessary for normal operation. In addition, one skilled in the art can understand that the above-mentioned device may also only include components necessary to implement the solution of the present disclosure, without including all the components as shown in the figure.

As can be seen from the description of the above implementations, one skilled in the art can clearly understand that the present disclosure can be implemented by means of software plus a necessary general hardware platform. Based on this understanding, the technical solution of the present disclosure or the part that contributes to existing technologies can be embodied in a form of a software product. Such computer software product can be stored in a storage medium, such as ROM/RAM, a disk, an optical disk, etc., and includes a number of instructions for enabling a computer device (which can be a personal computer, a server, or a network device, etc.) to execute the methods described in the various embodiments or certain parts of the embodiments of the present disclosure.

Each embodiment in this specification is described in a progressive manner. The same or similar parts between the embodiments can be referred to each other. Each embodiment focuses on aspects differently from other embodiments. In particular, since systems or system embodiments are basically similar to the method embodiments, a description thereof is relatively simple. For the relevant parts, reference can be made to the parts of the description of the method embodiments. The systems and system embodiments described above are only schematic, wherein the units described as separate components may or may not be physically separated. The components displayed as units may or may not be physical units, that is, they may be located in one place, or may be distributed on multiple network units. Some or all of the modules can be selected according to actual needs to achieve the purpose of the solution of the embodiments. One of ordinary skill in the art can understand and implement thereof without making any creative effort.

The method and electronic device for generating article content provided by the present disclosure are described in detail above. This text uses specific examples to explain the principles and implementation methods of the present disclosure. The description of the above embodiments is only used to help understand the method and its core idea of the present disclosure. At the same time, for one of ordinary skill in the art, there will be changes in the specific implementation methods and application scopes according to the ideas of the present disclosure. In summary, the content of this specification should not be understood as a limitation on the present disclosure.

What is claimed is:

1. A method implemented by one or more computing device, the method comprising:
constructing a subject keyword library by collecting industry trend data, and collecting content materials for article generation based on subject keywords in the library;
in response to a request for generating an industry information article, determining a target subject keyword, and constructing a prompt word text for dialogue with an artificial intelligence (AI) large language model according to the target subject keyword, to enable the AI large language model to generate an article subject;
screening multiple segments of target content materials from the content materials according to the article subject and the target subject keyword;
constructing the prompt word text for dialogue with the AI large language model according to the article subject and the target content materials, to enable the AI large language model to generate an article outline according to the multiple segments of the target content materials, the article outline including multiple sub-subjects; and
calling the AI large language model multiple times to generate corresponding text contents for the multiple sub-subjects respectively according to the article subject, the multiple sub-subjects and the target content materials, to generate a target article according to the article subject and the text contents corresponding to the multiple sub-subjects.

2. The method according to claim 1, further comprising:
according to pre-divided populations and respective population labels corresponding thereto, marking the subject keywords to establish an association relationship between the subject keywords and the populations, wherein determining the target subject keyword in response to the request for generating the industry information article includes:
in response to a request for generating an industry information article for a target population, determining target subject keyword(s) having an association relationship with the target population.

3. The method according to claim 1, wherein the content materials include: a content material with timeliness, so that the generated target article includes a corresponding content with timeliness.

4. The method according to claim 3, wherein the content materials are further associated with timeliness and/or source information, so that when generating an article, the target content materials are filtered and selected in combination with the timeliness and/or the source information.

5. The method according to claim 1, wherein screening the multiple segments of the target content materials from the content materials comprises:
screening multiple target content materials with a same or similar style/type from the content materials, to allow a content in the generated target article to have uniformity in style and/or writing ideas.

6. The method according to claim 1, wherein:
when generating the article outline, the AI large language model is specifically used to: generate sub-subjects for the multiple target content materials respectively, and extract multiple target sub-subjects from the sub-subjects corresponding to the multiple target content materials respectively, to generate the article outline from the multiple target sub-subjects.

7. The method according to claim 1, further comprising:
after the AI large language model generates the corresponding text contents for the multiple sub-subjects respectively, extracting a timeliness-related content in the generated text contents, and determining content keywords of the timeliness-related content; and
initiating a content search to a target search engine system according to the content keywords, and performing a text matching between a searched content and the timeliness-related content generated by the AI large language model to determine whether factual errors in the timeliness-related content generated by the AI large language model exist.

8. The method according to claim 1, wherein generating the corresponding text contents for the multiple sub-subjects respectively comprises:
using an AI large language model of a text generation type to generate the corresponding text contents for the multiple sub-subjects, and using an AI large language model of an image generation type to generate corresponding illustration contents for the multiple sub-subjects.

9. The method according to claim 8, wherein:
before using the AI large language model of the image generation type to generate an illustration content for a target sub-subject, using the AI large language model of the text generation type to generate a prompt word text for dialogue with the AI large language model of the image generation type, to enable the AI large language model of the image generation type to generate the illustration content for the target sub-subject according to the prompt word text.

10. The method according to claim 9, wherein using the AI large language model of the text generation type to generate the prompt word text for dialogue with the AI large language model of the image generation type comprises:
according to the multiple sub-subjects and the generated text contents corresponding to the multiple sub-subjects, constructing a prompt word text for the AI large language model of the text generation type, to enable the AI large language model of the text generation type to generate the prompt word text for dialogue with the AI large language model of the image generation type.

11. The method according to claim 9, wherein using the AI large language model of the text generation type to generate the prompt word text for dialogue with the AI large language model of the image generation type comprises:
if the content materials include image content materials that are associated with text content materials, determining image content materials associated with text content materials to be used when generating the texts content corresponding to the multiple sub-subjects, and using the AI large language model to generate text description contents of the image content materials; and
using the text description contents corresponding to the image content materials to construct the prompt word text for the AI large language model of the text generation type, so that the AI large language model of the text generation type generates the prompt word text for dialogue with the AI large language model of the image generation type.

12. One or more computer readable media storing executable instructions that, when executed by one or more processors, cause the one or more processors to perform acts comprising:
constructing a subject keyword library by collecting industry trend data, and collecting content materials for article generation based on subject keywords in the library;
in response to a request for generating an article, determining a target subject keyword, and constructing a prompt word text for dialogue with an artificial intelligence (AI) large language model according to the target subject keyword, to enable the AI large language model to generate an article subject;
screening multiple segments of target content materials from the content materials according to the article subject and the target subject keyword;
constructing the prompt word text for dialogue with the AI large language model according to the article subject and the target content materials, to enable the AI large language model to generate an article outline according to the multiple segments of the target content materials, the article outline including multiple sub-subjects; and
calling the AI large language model multiple times to generate corresponding text contents for the multiple sub-subjects respectively according to the article subject, the multiple sub-subjects and the target content materials, to generate a target article according to the article subject and the text contents corresponding to the multiple sub-subjects.

13. The one or more computer readable media according to claim 12, the acts further comprising:
according to pre-divided populations and respective population labels corresponding thereto, marking the subject keywords to establish an association relationship between the subject keywords and the populations, wherein determining the target subject keyword in response to the request for generating the industry information article includes:
in response to a request for generating an industry information article for a target population, determining target subject keyword(s) having an association relationship with the target population.

14. The one or more computer readable media according to claim 11, wherein the content materials include: a content material with timeliness, so that the generated target article includes a corresponding content with timeliness.

15. The one or more computer readable media according to claim 12, wherein screening the multiple segments of the target content materials from the content materials comprises:
screening multiple target content materials with a same or similar style/type from the content materials, to allow a content in the generated target article to have uniformity in style and/or writing ideas.

16. The one or more computer readable media according to claim 12 wherein:
when generating the article outline, the AI large language model is specifically used to: generate sub-subjects for the multiple target content materials respectively, and extract multiple target sub-subjects from the sub-subjects corresponding to the multiple target content materials respectively, to generate the article outline from the multiple target sub-subjects.

17. The one or more computer readable media according to claim 12, the acts further comprising:
after the AI large language model generates the corresponding text contents for the multiple sub-subjects respectively, extracting a timeliness-related content in the generated text contents, and determining content keywords of the timeliness-related content; and
initiating a content search to a target search engine system according to the content keywords, and performing a text matching between a searched content and the timeliness-related content generated by the AI large language model to determine whether factual errors in the timeliness-related content generated by the AI large language model exist.

18. The one or more computer readable media according to claim 12, wherein generating the corresponding text contents for the multiple sub-subjects respectively comprises:
using an AI large language model of a text generation type to generate the corresponding text contents for the multiple sub-subjects, and using an AI large language model of an image generation type to generate corresponding illustration contents for the multiple sub-subjects.

19. The one or more computer readable media according to claim 18, wherein:
before using the AI large language model of the image generation type to generate an illustration content for a target sub-subject, using the AI large language model of the text generation type to generate a prompt word text for dialogue with the AI large language model of the image generation type, to enable the AI large language model of the image generation type to generate the illustration content for the target sub-subject according to the prompt word text.

20. An apparatus comprising:
one or more processors; and
a memory storing executable instructions that, when executed by the one or more processors, cause the one or more processors to perform acts comprising:
constructing a subject keyword library by collecting industry trend data, and collecting content materials for article generation based on subject keywords in the library;
in response to a request for generating an industry information article, determining a target subject keyword, and constructing a prompt word text for dialogue with an artificial intelligence AI large language model according to the target subject keyword, to enable the AI large language model to generate an article subject;
screening multiple segments of target content materials from the content materials according to the article subject and the target subject keyword;
constructing the prompt word text for dialogue with the AI large language model according to the article subject and the target content materials, to enable the AI large language model to generate an article outline according to the multiple segments of the target content materials, the article outline including multiple sub-subjects; and
calling the AI large language model multiple times to generate corresponding text contents for the multiple sub-subjects respectively according to the article subject, the multiple sub-subjects and the target content materials, to generate a target article according to the article subject and the text contents corresponding to the multiple sub-subjects.
